SEQUENCE LISTING (2 sequences)

SEQ ID NO: 1 - DNA, 50 bp, Artificial Sequence
  Test oligonucleotide for AFM Tip
taaaaaaaaaaaagcggtaagggaaatcgcgtcataaaaaaatatcgagt

SEQ ID NO: 2 - DNA, 50 bp, Artificial Sequence
  Test oligonucleotide bound to a substrate surface
actcgatatttttttatgacgcgatttcccttaccgctttttttttttta

(19) United States
(12) Patent Application Publication
(10) Pub. No.: US 2011/0160088 A1
(43) Pub. Date: Jun. 30, 2011

(54) Solid Substrates With Surface Bound Molecules and Methods For Producing and Using the Same

(76) Inventors: Joon Won Park, Pohang (KR); Bong Jin Hong, Pohang (KR); Duk Hoe Kim, Pohang (KR)

(21) Appl. No.: 12/599,719

(22) PCT Filed: Sep. 17, 2008
(86) PCT No.: PCT/IB08/03808

§ 371 Date: Nov. 11, 2009

Related U.S. Application Data
(60) Provisional application No. 60/973,079, filed on Sep. 17, 2007.

(51) Int. Cl. C40B 40/06; C40B 50/18; C40B 40/04; C40B 40/10

(52) U.S. Cl. 506/16; 506/32; 506/15; 506/18

(57) ABSTRACT

The present invention provides solid substrates comprising a small number of molecules, for example, ten or less molecules on the convex surface, e.g., on the apex, and methods for producing and using the same.

### CROSS-REFERENCE TO RELATED APPLICATIONS

This application claims the priority benefit of U.S. Provisional Application No. 60/973,079, filed Sep. 17, 2007, which is incorporated herein by reference in its entirety.

### FIELD OF THE INVENTION

The present invention relates to solid substrates comprising a small number of molecules, for example, ten or less molecules on the convex surface, e.g., on the apex, and methods for producing and using the same.

### BACKGROUND OF THE INVENTION

Initially, Atomic Force Microscope (AFM) was developed for the observation of solid surface topography. Currently, AFM is used in a wide range of applications including, but not limited to, measuring interactions between biomolecules such as in drug screening. Ability to measure the interaction between biomolecules is a powerful analytical tool that allows identification of various association and dissociation phenomena between biomolecules. For example, AFM is sometimes used to find the position and distribution of a specific ligand on the cell surface. While fluorescence microscope and radioisotope have been used to identify the distribution of ligands on the cell surface, these methods can only show distribution of tens to hundreds of conglomerated ligands in the micron-sized scale. In contrast, measurement of interacting forces between biomolecules with AFM provides more accurate and detailed analysis allowing a possibility of tracking individual position of the nano-sized ligands and observation of individual life phenomena.

Unfortunately, conventional methods of immobilizing biomolecules onto the AFM tip typically result in having biomolecules being attached not only on or near the apex of the tip but on various AFM tip locations, thus leading to a relatively low resolution of AFM. To overcome such a limitation, some have used high dilution methods or mixed monolayer methods when introducing the biomolecules onto the AFM tip. Although these methods reduce the relative population density of biomolecules immobilized on the AFM tip, they have not been successful in effectively immobilizing the biomolecules specifically on the apex of the AFM tip and in many instances the biomolecules could not be immobilized on the apex of the AFM tip.

Besides aforementioned studies on the measurement of interaction between biomolecules by means of AFM, other applications of the AFM have recently been attempted. For example, currently some have attempted to introduce compounds like carbon nanotubes or nanoparticles onto the apex of the AFM tip. But currently available methods are not adapted for selectively modifying the apex of the AFM tip.

Accordingly, there is a need for selectively modifying the apex of the AFM tip or the apex of any other convex surface.

### SUMMARY OF THE INVENTION

Some aspects of the invention provide a method for modifying a solid substrate surface and methods for using the same. In particular, methods of the invention involve modifying or attaching a probe, a receptor, a ligand, or any other material or a molecule on a solid substrate that comprises a convex surface. As used herein, the term “convex surface” refers to any surface that protrudes or bulges outward or generally above the horizontal plane of the surface. A convex surface can be a gradual curvature, a sharp protrusion, or any combination thereof. Typically, solid substrates modified by methods of the invention are those that are used in analytical devices such as, but not limited to, scanning probe microscope (SPM), atomic force microscope (AFM), electric force microscope (EFM), magnetic force microscope (MFM), and other analytical devices that is capable of analyzing a few molecules, i.e., 10 or less molecules, typically 5 of less molecules, often 3 or less molecules, and more often a single molecule.

Methods of the invention have a successful probability (i.e., success rate) of attaching a few molecules on the convex surface of at least about 50%, typically at least about 60%, often at least about 70% and more often at least about 75%. Methods of the invention comprise:
attaching a receptor to a convex surface of a first solid substrate surface to produce a receptor-bound substrate comprising a plurality of receptors;
contacting the receptor-bound substrate with a ligand that is bound to the surface of a second solid substrate under conditions sufficient to produce a receptor-ligand complex bound solid substrate wherein only a portion of the plurality of receptors is complexed to the ligand; and
modifying the receptor-ligand complex to produce a surface modified solid substrate.

As stated above, such methods of the invention provide modification of the solid substrate surface (e.g., first solid substrate surface) such that only a few molecules are attached to the convex surface. Often modification of the receptor-ligand complex provides successfully attaching only a single desired molecule.

Unless the context requires otherwise, the term “ligand” refers to any substance that is capable of binding selectively with a receptor. A ligand can be an antigen, an antibody, an oligonucleotide, an oligopeptide (including proteins, hormone, etc.), an enzyme, a substrate, a drug, a drug-receptor, cell surface, receptor agonists, partial agonists, mixed agonists, antagonists, response-inducing or stimulus molecules, drugs, hormones, pheromones, transmitters, autacoids, growth factors, cytokines, prosthetic groups, coenzymes, cofactors, substrates, precursors, vitamins, toxins, regulatory factors, antigens, haptens, carbohydrates, molecular mimics, structural molecules, effector molecules, selectable molecules, biotin, digoxigenin, cross-reactants, analogs, competitors or derivatives of these molecules as well as library-selected nonoligonucleotide molecules capable of specifically binding to selected targets and conjugates formed by attaching any of these molecules to a second molecule, and any other molecule that binds selectively with a corresponding receptor.

Unless the context requires otherwise, the term “receptor” refers to any substance that is capable of binding selectively with a corresponding ligand. It should be appreciated that unless the context requires otherwise, the terms “ligand” and “receptor” do not refer to any particular substance, or size or binding relationship. These terms are only operational terms that indicate selective binding between the ligand and the corresponding receptor where the compound that is bound to the first solid substrate surface is referred to as a receptor and any substance that selectively binds to the receptor is referred to as a ligand. Thus, if an antibody is attached to the first solid substrate surface then the antibody is a receptor and the corresponding antigen is a ligand. However, if an antigen is attached to the first solid substrate surface then the antigen is a receptor and the corresponding antibody is a ligand.

In some embodiments, about 3 or less of the receptors are complexed to the ligand. Often only a single receptor is complexed to the ligand, which then leads to attachment of only a single desired molecule following the modification of the receptor-ligand complex.

The receptor-ligand complex can be any combination of two or more different compounds that can bind to one another to form a relatively tight interaction, e.g., through electrostatic interaction, van der Waal's force, ionic bond, covalent bond, hydrogen bond, and any other physical phenomenals or characteristics that allow a formation of a complex based at least in part on some form of selectivity. In some embodiments, the receptor-ligand complex is a double stranded oligonucleotide, antigen-antibody complex, oligopeptide-small molecule complex, or oligopeptide-oligopeptide complex.

The success probability (or the success rate) for forming the receptor-ligand complex can depend on the nature or identity of the receptor-ligand. However, in general the success rate of methods of the present invention is at least 50%, typically at least 60%, often at least 70%, and more often at least 75%. In comparison, conventionally available methods have the success rate for attaching only a single molecule on a solid substrate surface is about 35% or less. Accordingly, methods of the invention provide a significantly higher success rate than what is currently available.

When the receptor-ligand complex is a double stranded DNA (dsDNA), i.e., a DNA that is hybridized to a complementary DNA, there are a variety of methods for modifying the receptor-ligand complex. In many instances, the modification step involves either modifying the dsDNA (i.e., the receptor-ligand complex) itself directly, i.e., without “denaturing” the dsDNA. In other instances, the modification step involves “uncomplexing” the receptor-ligand complex, i.e., denaturing the dsDNA to reform a ssDNA and hybridizing with another complementary ssDNA that is different from the complementary that has been removed by denaturing, e.g., another complementary ssDNA that has been linked to other moieties such as a probe, label, enzyme, catalyst, etc. In one particular embodiment, the step of modifying the receptor-ligand complex further comprises contacting the double stranded oligonucleotide with an intercalator-metal catalyst complex under conditions sufficient to produce the surface modified solid substrate comprising a surface bound double stranded oligonucleotide with the intercalator-metal catalyst intercalated therein.

In some embodiments, the step of modifying the receptor-ligand complex comprises:
denaturing the double stranded oligonucleotide to produce a single strand oligonucleotide-bound substrate; and
hybridizing the single strand oligonucleotide with
   (i) a labeled complementary oligonucleotide under conditions sufficient to produce the surface modified solid substrate comprising a surface bound labeled double-stranded oligonucleotide; or
   (ii) a complementary oligonucleotide comprising an enzyme or a catalyst under conditions sufficient to produce the surface modified solid substrate comprising the enzyme or the catalyst that is attached to a surface bound double-stranded oligonucleotide.

In some embodiments, methods of the invention further comprise the step of cleaving from the solid substrate surface at least a portion of the unbound single stranded oligonucleotides prior to the step of denaturing the double stranded oligonucleotide. In this manner, the unreacted or uncomplexed receptors (i.e., ssDNAs) are removed from the solid substrate surface before modifying the receptor-ligand complex. Such removal eliminates a possible reaction competition from undesired receptors. Often all or substantially all unreacted receptors is cleaved from the solid substrate surface or rendered relatively unreactive. For ssDNAs, this can be achieved by a ssDNA cleavage enzyme, which are well known to one skilled in the art.

Still in other embodiments, the step of modifying the receptor-ligand complex further comprises contacting the double stranded oligonucleotide with a metal ion under conditions sufficient to form a double stranded oligonucleotide-metal ion complex; and reducing the metal ion under conditions sufficient to produce the surface modified solid substrate comprising a surface bound metal nanorod.

Still in other embodiments, the receptor-ligand complex is an antigen-antibody complex. Within these embodiments, in some cases the step of modifying the receptor-ligand complex comprises contacting the antigen-antibody complex with a second antibody under conditions sufficient to produce the surface modified solid substrate comprising a surface bound complex of antigen-antibody-second antibody. In other cases within these embodiments, the step of modifying the receptor-ligand complex further comprises adding an enzyme-linked secondary antibody under conditions sufficient to produce the surface modified solid substrate comprising a surface bound complex of antibody-antigen-enzyme linked secondary antibody. Still in other cases within these embodiments, the step of modifying the receptor-ligand complex further comprises adding a metal-linked secondary antibody under conditions sufficient to produce the surface modified substrate comprising a surface bound complex of antibody-antigen-metal linked secondary antibody. Suitable conditions for these cases are well known to one skilled in the art.

Yet in other embodiments, the receptor is attached to the first solid substrate via a surface-bound linker. In certain instances within these embodiments, the surface-bound linker comprises:
a central atom;
a functional group that is attached to the central atom through a linker and is attached to a receptor; and
a base portion attached to the central atom and having a plurality of termini that are attached to the surface of the first solid support.

In many instances, the surface-bound linker is of the formula:

Z—[R¹]ₘ-Q¹-{[R²-Q²]ₐ-{(R³-Q³)_{b}-[(R⁴-Q⁴)_{c}-(R⁵—Y)ₓ]_{y}}_{z}}ₙ I

wherein
each of m, a, b, and c is independently 0 or 1;
x is 1 when c is 0 or when c is 1, x is an integer from 1 to the oxidation state of Q⁴−1;
y is 1 when b is 0 or when b is 1, y is an integer from 1 to the oxidation state of Q³−1;
z is 1 when a is 0 or when a is 1, z is an integer from 1 to the oxidation state of Q²−1;
n is an integer from 1 to the oxidation state of Q¹−1;
Q¹ is a central atom having the oxidation state of at least 3;
each of Q², Q³ and Q⁴ is independently a branch atom having the oxidation state of at least 3;
each of R¹, R², R³, R⁴, and R⁵ is independently a linker;
Z is the functional group that is attached to a receptor; and
each of Y is independently a functional group on the terminus of said base portion, wherein a plurality of Y are attached to said first surface of said solid support,
   provided the product of n, x, y, and z is at least 3.

It should be appreciated that when a, b or c is 1 and the corresponding z, y or x is less than the oxidation state of Q²−1, Q³−1 or Q⁴−1, respectively, the remaining atoms attached to Q², Q³, or Q⁴, respectively, is hydrogen. As used herein, “Q” refers to any one of or all of Q¹, Q², Q³, Q⁴. Typically, Q is any atom in group IVA or VA of the periodic table. Exemplary atoms for Q include, but are not limited to, N, P, C, Si, Ge, and the like. Often, Q is N, P, C, or Si.

As can be seen in Formula I, Z is attached to the central atom optionally through a linker R¹. Often a is 1 such that Z is attached to the central atom through a linker R¹.

Yet in other embodiments, Z comprises a heteroatom selected from the group consisting of N, O, S, P, and a combination thereof.

Each Y can be independently a function group. That is, each Y can be independent of the other Y group. Often, however, all of the Y's are the same functional group. However, in general Z and Y are different functional groups. In some instances, Z and Y can be the same functional group, but one or the other is in a protected form. Such differences in functional group and/or the presence of a protecting group allow one to distinguish the reactivity of Z and Y, thereby allowing one to attach the dendron to the solid support via a plurality of Y's and allows attachment of a probe on Z.

It should be noted that the first and/or the second solid substrate can include the surface bound-linker. Moreover, the surface bound-linker of the first and/or the second solid substrate can be a dendron. Such dendrons need not be the same between the first and the second solid substrate. In some embodiments, the first solid substrate comprises dendrons as a surface bound-linker. In other embodiments, the second solid substrate comprises dendrons as a surface bound-linker. Still in other embodiments, the first and the second solid substrates both comprise dendrons as a surface bound-linker. In the latter cases, dendrons for the first and the second solid substrates need not be the same. In some particular embodiments, dendron is of Formula I disclosed herein.

In one particular embodiment, the first solid substrate is an atomic force microscope tip.

Other aspects of the invention provide a solid substrate adapted for performing an analytical analysis comprising a convex surface. The convex surface comprises a plurality of surface bound dendrons comprising a receptor adapted for forming a complex with a ligand such that when the plurality of receptors is contacted with a ligand that is bound to the surface of a second solid substrate only a portion of plurality of receptors becomes complexed to the ligand.

In some embodiments, the solid substrate is an atomic force microscope tip.

Still in other embodiments, the dendron is of Formula I disclosed herein.

Yet in other embodiments, the receptor is an oligonucleotide, an oligopeptide, an antibody, an antigen, a receptor, an enzyme, aptamer, or biologically or pharmaceutically active compound.

Yet other aspects of the invention provide an article suitable for use in an Atomic Force Microscope comprising a convex surface and 3 or less probe molecules attached to the apex of the convex surface. In some embodiments, the convex surface comprises only a single probe molecule.

Still other aspects of the invention provide a method for modifying a convex surface of a solid substrate comprising a convex surface bound ssDNA. The method generally comprises contacting the convex surface bound ssDNA with a linker ssDNA that is hybridized to a ssDNA that is attached to the surface of an other solid substrate under conditions sufficient to produce a convex surface modified solid substrate comprising the linker ssDNA that is complexed to the ssDNA that is attached to the convex surface of the solid substrate, wherein the linker ssDNA comprises:
(i) a first DNA portion that is capable of hybridizing to the ssDNA that is attached to the convex surface of the solid substrate;
(ii) a second DNA portion that is capable of hybridizing to the ssDNA that is attached to the other solid substrate surface; and
(iii) optionally a probe or a label.

In some embodiments, such methods utilize dendrons, such as those disclosed herein (i.e., dendrons of Formula I) as well as other dendrons known to one skilled in the art.

In other embodiments, methods provide attachment of 10 or fewer molecules, typically 5 or fewer molecules, often 3 or fewer molecules, and more often only a single molecule on the convex surface of the solid substrate.

Methods can also include attaching a ssDNA to a convex surface of the solid substrate prior to contacting with the linker ssDNA.

In addition, the linker ssDNA or the ssDNA that is hybridized to the linker ssDNA can be further modified as disclosed herein.

### BRIEF DESCRIPTION OF THE DRAWINGS

FIG. 1 shows a typical AFM tip and an enlarged schematic illustration of the apex of an AFM tip;

FIGS. 2A and 2B show a schematic illustration of a method for modifying the AFM tip and a matrix surface, respectively, using a self-assembly monolayer technology (e.g., immobilizing an oligonucleotide);

FIG. 3 is a schematic illustration for selectively immobilizing biomolecules on the apex of the AFM tip;

FIGS. 4A and 2B show a schematic illustration for modifying the AFM tip and matrix surface, respectively, using a self-assembly monolayer technology and a mesospaced technology (e.g., immobilizing a dendron molecule and an oligonucleotide);

FIG. 5 is a schematic illustration of a method for leaving one strand of intact single stranded (ss) oligonucleotide on the AFM tip using an enzymatic reaction;

FIG. 6A is an HPLC analysis graph of a single stranded oligonucleotide introduced onto the AFM tip prior to adding a cleavage enzyme;

FIG. 6B is an HPLC analysis graph of a single stranded oligonucleotide introduced onto the AFM tip 15 minutes after adding a cleavage enzyme;

FIG. 6C is an HPLC analysis graph of a single stranded oligonucleotide introduced onto the AFM tip 30 minutes after adding a cleavage enzyme;

FIG. 6D is an HPLC analysis graph of a single stranded oligonucleotide introduced onto the AFM tip 45 minutes after adding a cleavage enzyme;

FIG. 6E is an HPLC analysis graph of a single stranded oligonucleotide introduced onto the AFM tip 60 minutes after adding a cleavage enzyme;

FIG. 7A is an HPLC analysis graph of a single stranded oligonucleotide introduced onto the matrix surface prior to adding a cleavage enzyme;

FIG. 7B is an HPLC analysis graph of a single stranded oligonucleotide introduced onto the matrix surface 15 minutes after adding a cleavage enzyme;

FIG. 7C is an HPLC analysis graph of a single stranded oligonucleotide introduced onto the matrix surface 30 minutes after adding a cleavage enzyme;

FIG. 7D is an HPLC analysis graph of a single stranded oligonucleotide introduced onto the matrix surface 45 minutes after adding a cleavage enzyme;

FIG. 7E is an HPLC analysis graph of a single stranded oligonucleotide introduced onto the matrix surface 60 minutes after adding a cleavage enzyme;

FIG. 8A is an HPLC analysis graph of a mixture of a single stranded oligonucleotide and a double stranded oligonucleotide prior to adding a cleavage enzyme;

FIG. 8B is an HPLC analysis graph of a mixture of a single stranded oligonucleotide and a double stranded oligonucleotide 15 minutes after adding a cleavage enzyme;

FIG. 8C is an HPLC analysis graph of a mixture of a single stranded oligonucleotide and a double stranded oligonucleotide 30 minutes after adding a cleavage enzyme;

FIG. 8D is an HPLC analysis graph of a mixture of a single stranded oligonucleotide and a double stranded oligonucleotide 45 minutes after adding a cleavage enzyme;

FIG. 8E is an HPLC analysis graph of a mixture of a single stranded oligonucleotide and a double stranded oligonucleotide 60 minutes after adding a cleavage enzyme;

FIG. 9 is a bar graph showing a DNA-DNA interaction force in a buffer solution for the reaction of Mung bean nuclease;

FIG. 10 is a schematic illustration for modifying the apex of an AFM tip using an antigen-antibody reaction;

FIG. 11 is a schematic illustration for forming a metal nano-rod around a double stranded oligonucleotide;

FIG. 12 is a schematic illustration for modifying the apex of an AFM tip with an intercalator-metal catalyst conjugate;

FIG. 13 is a schematic illustration for modifying the apex of an AFM tip with a labeled (e.g., magnetic nano-particle) double stranded oligonucleotide;

FIG. 14 is a schematic illustration of a regioselective catalytic reaction between a substrate immobilized on a solid matrix surface and a catalyst (or an enzyme) that is attached to the apex of an AFM tip;

FIG. 15 illustrates a method for modifying the apex of an AFM tip with an oligonucleotide comprising a nano-particle by binding a nano-particle bound oligonucleotide to a complementarily (hybridization) portion of a linker oligonucleotide;

FIGS. 16A-C corresponds to (i) a schematic diagram illustrating how to generate the 27-acid dendron-modified substrate and AFM tip and attach the DNA probe molecule to the apex of the dendron; (ii) the structure of a 27-acid molecule; and (iii) a schematic illustration showing the APDES-modified substrate and the AFM tip have DNA probe molecules closely spaced, respectively;

FIGS. 17A-C show the result of isolating a single DNA immobilized AuNP; in particular FIG. 17A shows 3% agarose gel electrophoresis of a linker DNA immobilized AuNPs (where lane 1 contains phosphine-capped AuNPs as a reference) and FIG. 17B shows 3% agarose gel electrophoresis of a complimentary DNA immobilized AuNPs for hybridization to the captured linker DNA on an AFM tip (where lane 1 contains phosphine-capped AuNPs as a reference); as the FIGS. 17A and 17B shows, the separation between each band was enough to cut and collect the gel containing a single DNA immobilized AuNPs only; FIG. 17C shows a sequence of thiolated DNA molecules; and

FIG. 18A shows a schematic drawing of capturing a single linker DNA molecule;

FIG. 18B shows the DNA sequences used for an AFM experiment;

FIG. 18C is a TEM image of a gold labeled single linker DNA on the top of an AFM tip;

FIG. 18D is a schematic drawing of hybridization of a gold labeled DNA molecule to a captured gold labeled linker DNA;

FIG. 18E is a TEM image of a captured gold labeled linker DNA hybridized with another gold labeled DNA molecule; and

FIG. 19 is TEM images of the AFM tips showing successful capturing of a single linker DNA molecule.

### DETAILED DESCRIPTION OF THE INVENTION

As used herein, “aptamer” means a single-stranded, partially single-stranded, partially double-stranded or double-stranded nucleotide sequence, advantageously replicable nucleotide sequence, capable of specifically recognizing a selected nonoligonucleotide molecule or group of molecules by a mechanism other than Watson-Crick base pairing or triplex formation.

As used herein, “bifunctional,” “trifunctional” and “multifunctional,” when used in reference to a synthetic polymer or multivalent homo- or heteropolymeric hybrid structure, mean bivalent, trivalent or multivalent, as the case may be, or comprising two, three or multiple specific recognition elements, defined sequence segments or attachment sites.

As used herein, “dendritic molecule” is a molecule exhibiting regular dendritic branching, formed by the sequential or generational addition of branched layers to or from a core.

The term “dendron” refers to a polymer exhibiting regular dendritic branching, formed by the sequential or generational addition of branched layers to or from a core. The term dendritic polymer encompasses “dendrimers”, which are characterized by a core, at least one interior branched layer, and a surface branched layer (see, e.g., Petar et al. Pages 641-645 In Chem. in Britain, (August 1994). A “dendron” is a species of dendrimer having branches emanating from a focal point or a central atom, which is or can be joined to a core, either directly or through a linking moiety to form a dendrimer. Many dendrimers comprise two or more dendrons joined to a common core.

Dendrons include, but are not limited to, symmetrical and asymmetrical branching dendrimers, cascade molecules, arborols, and the like. In some embodiments, the branch arms are of equal length. However, it is also contemplated that asymmetric dendrimers may also be used.

As used herein, the terms “immobilized” and “attached (to a solid substrate surface)” are used interchangeably herein and mean insolubilized or comprising, attached to or operatively associated with an insoluble, partially insoluble, colloidal, particulate, dispersed, suspended and/or dehydrated substance or a molecule or solid phase comprising or attached to a solid support.

As used herein, “nucleotide” refers to both natural and synthetic nucleotide molecules that can be used in place of naturally occurring bases in nucleic acid synthesis and processing, e.g., enzymatic as well as chemical synthesis and processing. Thus, nucleotide includes modified nucleotides capable of base pairing and optionally synthetic bases that do not comprise adenine, guanine, cytosine, thymidine, uracil or minor bases. For example, “nucleotide” includes, but is not limited to, modified purines and pyrimidines, minor bases, convertible nucleosides, structural analogs of purines and pyrimidines, labeled, derivatized and modified nucleosides and nucleotides, conjugated nucleosides and nucleotides, sequence modifiers, terminus modifiers, spacer modifiers, and nucleotides with backbone modifications, including, but not limited to, ribose-modified nucleotides, phosphoramidates, phosphorothioates, phosphonamidites, methyl phosphonates, methyl phosphoramidites, methyl phosphonamidites, 5′-β-cyanoethyl phosphoramidites, methylenephosphonates, phosphorodithioates, peptide nucleic acids, achiral and neutral internucleotidic linkages and nonnucleotide bridges such as polyethylene glycol, aromatic polyamides and lipids.

As used herein, “polypeptide”, “peptide” and “protein” are used interchangeably herein to refer to a polymer of amino acid residues or analogs. The terms apply to amino acid polymers in which one or more amino acid residue is an artificial chemical analogue of a corresponding naturally occurring amino acid, as well as to naturally occurring amino acid polymers. The term may also include variants on the traditional peptide linkage joining the amino acids making up the polypeptide.

As used herein, “protecting group” refers to a group that is joined to a reactive group (e.g., a hydroxyl or an amine) on a molecule. The protecting group is chosen to prevent reaction of the particular radical during one or more steps of a chemical reaction. Generally the particular protecting group is chosen so as to permit removal at a later time to restore the reactive group without altering other reactive groups present in the molecule. The choice of a protecting group is a function of the particular radical to be protected and the compounds to which it will be exposed. The selection of protecting groups is well known to those of skill in the art. See, for example Greene et al., Protective Groups in Organic Synthesis, 2nd ed., John Wiley & Sons, Inc. Somerset, N.J. (1991), which is incorporated by reference herein in its entirety.

As used herein, “solid support” refers to a composition comprising an immobilization matrix such as but not limited to, insolubilized substance, solid phase, surface, substrate, layer, coating, woven or nonwoven fiber, matrix, crystal, membrane, insoluble polymer, plastic, glass, biological or biocompatible or bioerodible or biodegradable polymer or matrix, microparticle or nanoparticle. Solid supports include, for example and without limitation, monolayers, bilayers, commercial membranes, resins, matrices, fibers, separation media, chromatography supports, polymers, plastics, glass, mica, gold, beads, microspheres, nanospheres, silicon, gallium arsenide, organic and inorganic metals, semiconductors, insulators, microstructures and nanostructures. Microstructures and nanostructures may include, without limitation, microminiaturized, nanometer-scale and supramolecular probes, tips, bars, pegs, plugs, rods, sleeves, wires, filaments, and tubes.

As used herein, “substrate,” when used in reference to a substance, structure, surface or material, means a composition comprising a nonbiological, synthetic, nonliving, planar, spherical or flat surface that is not heretofore known to comprise a specific binding, hybridization or catalytic recognition site or a plurality of different recognition sites or a number of different recognition sites which exceeds the number of different molecular species comprising the surface, structure or material. The substrate may include, for example and without limitation, semiconductors, synthetic (organic) metals, synthetic semiconductors, insulators and dopants; metals, alloys, elements, compounds and minerals; synthetic, cleaved, etched, lithographed, printed, machined and microfabricated slides, devices, structures and surfaces; industrial polymers, plastics, membranes; silicon, silicates, glass, metals and ceramics; wood, paper, cardboard, cotton, wool, cloth, woven and nonwoven fibers, materials and fabrics; nanostructures and microstructures unmodified by immobilization probe molecules through a branched/linear polymer.

Unless the context requires otherwise, the term “ligand” refers to any substance that is capable of binding selectively with a probe. A ligand can be an antigen, an antibody, an oligonucleotide, an oligopeptide (including proteins, hormone, etc.), an enzyme, a substrate, a drug, a drug-receptor, cell surface, receptor agonists, partial agonists, mixed agonists, antagonists, response-inducing or stimulus molecules, drugs, hormones, pheromones, transmitters, autacoids, growth factors, cytokines, prosthetic groups, coenzymes, cofactors, substrates, precursors, vitamins, toxins, regulatory factors, antigens, haptens, carbohydrates, molecular mimics, structural molecules, effector molecules, selectable molecules, biotin, digoxigenin, crossreactants, analogs, competitors or derivatives of these molecules as well as library-selected nonoligonucleotide molecules capable of specifically binding to selected targets and conjugates formed by attaching any of these molecules to a second molecule, and any other molecule that binds selectively with a corresponding probe.

It should be appreciated that the terms “ligand” and “receptor” do not refer to any particular substance or size relationship. These terms are only operational terms that indicate selective binding between the ligand and the corresponding probe where the moiety that is bound to a substrate surface is referred to as a probe and any substance that selectively binds to the probe is referred to as a ligand. Thus, if an antibody is attached to the substrate surface then the antibody is a probe and the corresponding antigen is a ligand. However, if an antigen is attached to the substrate surface then the antigen is a probe and the corresponding antibody is a ligand.

The terms “nucleic acid”, “polynucleotide”, and “oligonucleotide” are used interchangable herein and refer to a deoxyribonucleotide or ribonucleotide polymer in either single- or double-stranded form, and unless otherwise limited, encompasses known analogs of natural nucleotides that hybridize to nucleic acids in a manner similar to naturally-occurring nucleotides. Examples of such analogs include, without limitation, phosphorothioates, phosphoramidates, methyl phosphonates, chiral-methyl phosphonates, 2-O-methyl ribonucleotides, and peptide-nucleic acids (PNAs). A “subsequence” or “segment” refers to a sequence of nucleotides that comprise a part of a longer sequence of nucleotides.

The term “complementary” means that one nucleic acid is identical to, or hybridizes selectively to, another nucleic acid molecule. Selectivity of hybridization exists when hybridization occurs that is more selective than total lack of specificity. Typically, selective hybridization will occur when there is at least about 55% identity over a stretch of at least 14-25 nucleotides, typically at least 65%, often at least 75%, and more often at least 90%.

The terms “identical” or percent “identity,” in the context of two or more nucleic acids or polypeptides, refer to two or more sequences or subsequences that are the same or have a specified percentage of nucleotides or amino acid residues that are the same, when compared and aligned for maximum correspondence, as measured using a sequence comparison algorithm such as those described below for example, or by visual inspection.

The phrase “substantially identical,” in the context of two nucleic acids, refers to two or more sequences or subsequences that have at least 75%, typically at least 80% or 85%, often at least 90%, 95% or higher nucleotide identity, when compared and aligned for maximum correspondence, as measured using a sequence comparison algorithm such as those described below for example, or by visual inspection. Generally, the substantial identity exists over a region of the sequences that is at least about 40-60 nucleotides in length, in other instances over a region at least 60-80 nucleotides in length, in still other instances at least 90-100 nucleotides in length, and in yet other instances the sequences are substantially identical over the full length of the sequences being compared, such as the coding region of a nucleotide for example.

Atomic force microscopy (AFM) has been used as a tool for studying molecular interactions because of its high sensitivity can sense pico newton-scale forces. Conventional methods of immobilizing biomolecules on an atomic force microscope (AFM) tip result in having biomolecules being attached not only on or near the apex of the tip but on various AFM tip locations. Such a relatively non-selective attachment of biomolecules on an AFM tip leads to a relatively low resolution of AFM. To investigate single molecular interactions only, many researchers have modified AFM tips and substrates with chemical compounds and nanowires. Recently, some have reported a method for the bottom-up assembly of DNA patterns using an AFM tip fabricated with self-assembled monolayers and long linkers to control the density of functional groups on the apex of the tip. Such a method had only 35% success probability in capturing a single DNA and transferring the captured DNA to a target area.

Some aspects of the present invention provide methods for attaching a few compounds (e.g., 10 or less, typically 5 or less, often 3 or less, and more often a single molecule) on the apex of an AFM tip or on the apex of any solid comprising a convex surface. Some embodiments provide methods for selectively attaching only one molecule on the apex of the AFM tip. Exemplary compounds that can be attached to the apex of an AFM tip include those that are well known to one skilled in the art such as, but not limited to, biomolecules (e.g., oligonucleotides, oligopeptides, enzymes, catalysts, receptors, proteins, DNA, etc.), small molecules (e.g., drugs, drug candidates, labels, probes, etc.), nanoparticles, nanowires, carbon nanotubes, and a combination of two or more thereof.

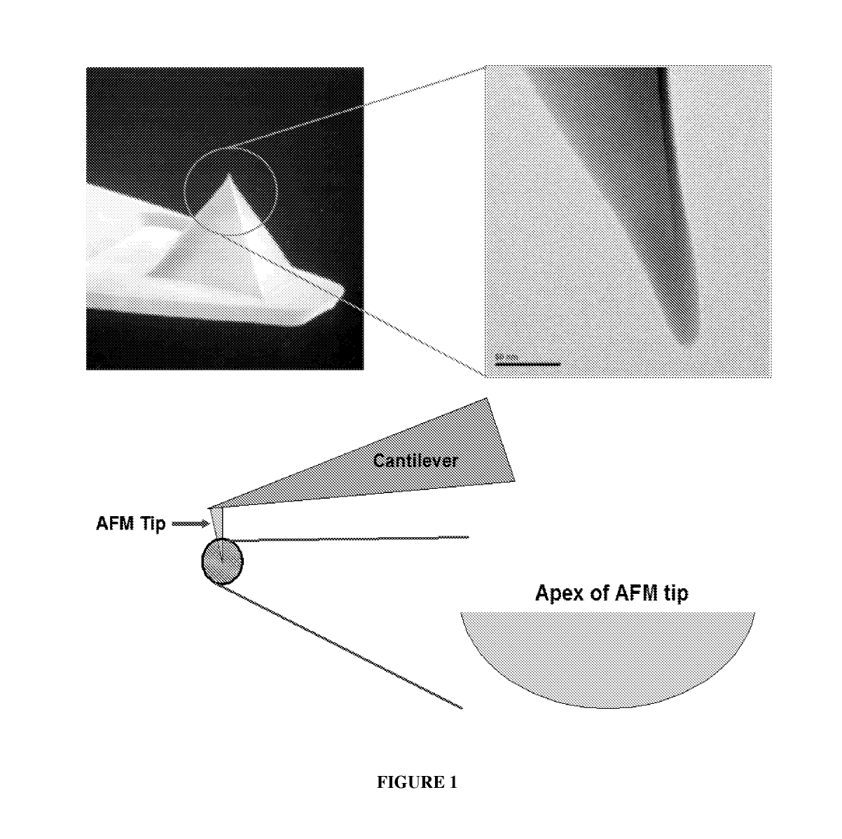

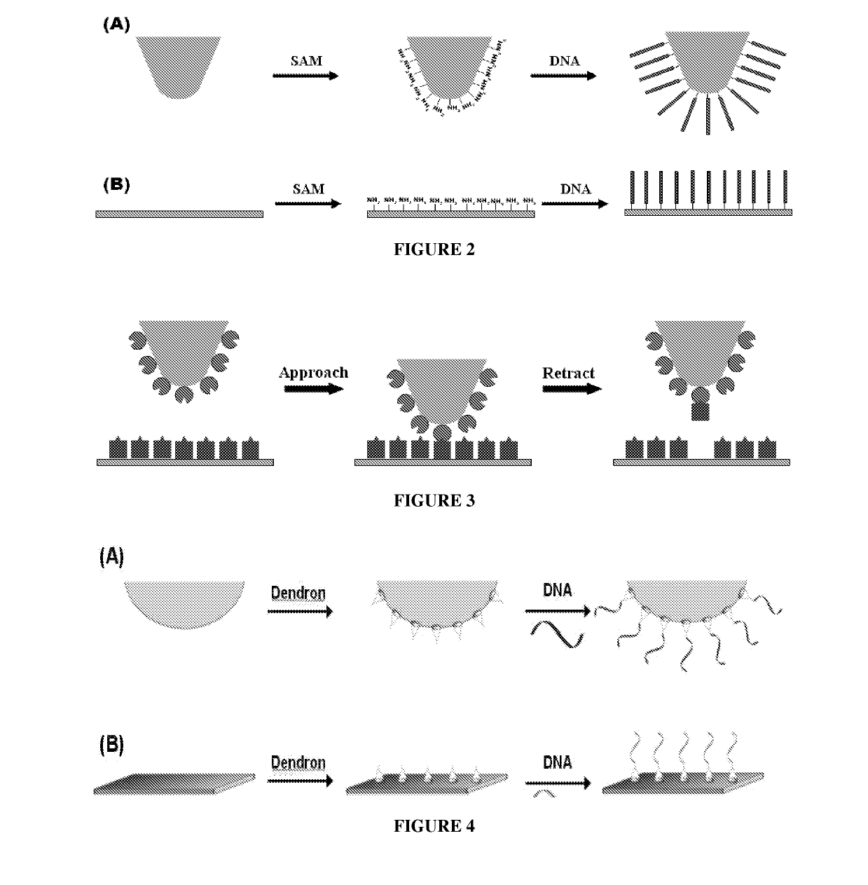

The apex of an AFM tip is typically a few nanometers in diameter as schematically illustrated in FIG. 1, and can be modified with various functional groups through self-assembly reaction as shown in FIG. 2. These functional groups can bind to various compounds such as biomolecules, chemical compounds, nano-particles, and nano-wires. It is possible to immobilize such compounds on the surface of an AFM tip using this self-assembly reaction and, theoretically, to modify only the apex of the tip with desired compounds in a manner shown in FIG. 3. For example, after immobilizing a DNA and a complementary DNA on the AFM tip and a matrix surface, respectively, the AFM tip is brought near the matrix surface under conditions sufficient to allow formation of a small number of double stranded DNA-DNA pairs only on the apex of the AFM tip. Addition of an enzyme that lyses single stranded DNA (ssDNA) then leaves intact dsDNA pairs that formed on the apex of the tip. The dsDNA can then be modified to a variety of moieties, for example, probes, labels, intercalating agents can be introduced, and various nanostructures can be formed from the dsDNA. Such modification techniques can be applied not only to DNA-DNA complexes, but to DNA-RNA, DNA-protein, RNA-protein, antigen-antibody, or biomolecule-chemical molecule complexes.

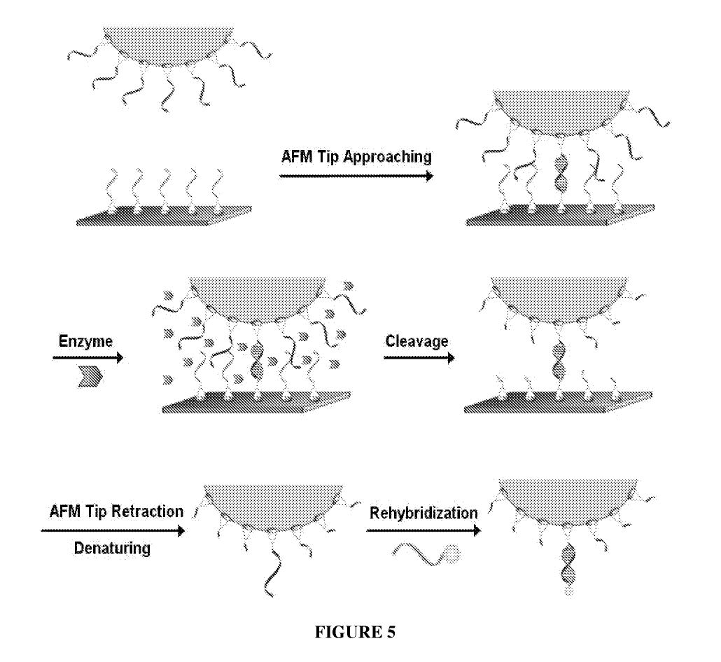

Furthermore, combination of any of the techniques disclosed herein or known to one skilled in the art with the meso-spaced technology as shown in FIG. 4 enables immobilization of a compound or molecule only on the apex of the AFM tip. Removing multiple interactions between biomolecules is one of the important factors in accurately measuring biomolecular interactions using the AFM. Without being bound by any theory, it is believed that in some instances, meso-spaced technology enables hybridized DNA-DNA pair to form only on the apex of the tip, and introduction of enzyme reaction using an in-vivo nano-machine, enables compound to be immobilized only on the apex of the tip (FIG. 5). As a result, methods of the present invention enable new studies and applications for AFM.

Some aspects of the invention include cleaving ssDNA that are attached on the surface while leaving a hybridized DNA-DNA pair using a ssDNA-selective lytic enzyme. Using such an enzyme leaves dsDNA on the apex of the AFM tip while removing unhybridized ssDNAs. There are various methods available for further modifying the dsDNA. For example, through rehybridization with a DNA modified with a various compounds, such as biomolecules, chemical molecules, nanoparticles, nanowires and carbon nanotube, the apex of the AFM tip can be modified with these compounds. In some embodiments, a metallization reaction of dsDNA comprising a metal particle produces a corresponding metal nanowire. In other embodiments, characteristics of a catalyst or an enzyme can be analyzed by using an AFM tip modified with the catalyst or the enzyme, respectively. Still in other embodiments, the apex of the AFM tip can be modified to study antigen-antibody interaction, protein-protein interaction, protein-DNA interaction, protein-RNA interaction, compound-compound interaction and compound-biomolecule interaction.

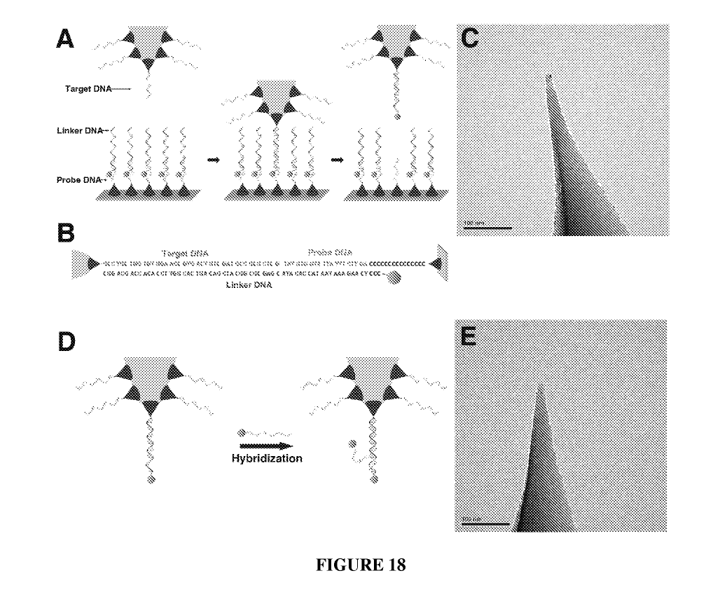

Some embodiments of the invention use self-assembled cone-shaped dendrons that were discovered by the present inventors. These dendrons provide effective spacing of the reactive moieties (e.g., DNA molecules) attached to the dendron apexes. Such controlled spacing removes lateral steric hindrance, enhances hybridization efficiency and reproducibility, and greatly simplifies the force-distance curve. These characteristics and results are expected to result in the dendron functionalized tips to greatly increase the probability to successfully measure a single molecular force. To illustrate the applicability of dendrons, a simple DNA capturing system based on DNA hybridization was designed as illustrated in FIG. 18.

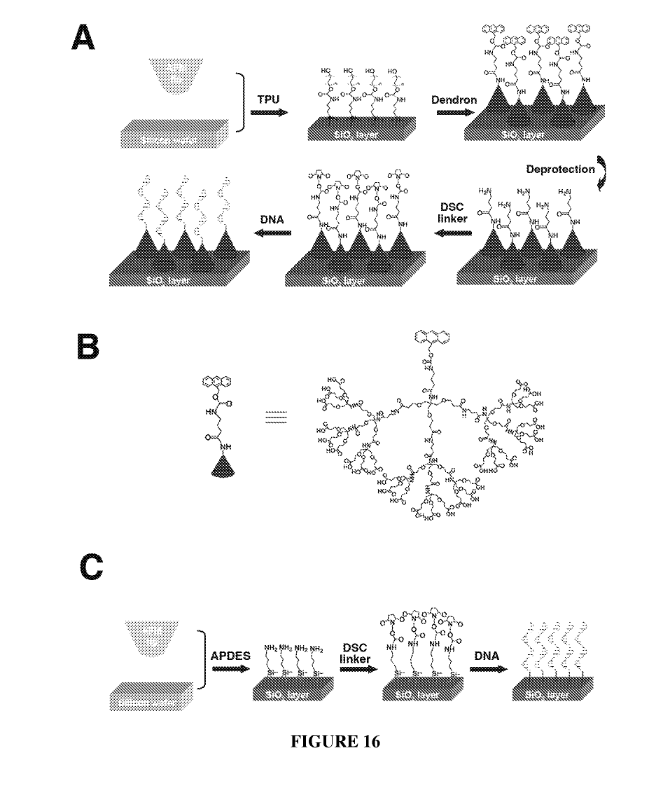

Referring to FIG. 18, each substrates and AFM tips were initially coated with N-(3-(triethoxysilyl)propyl)-O-polyethyleneoxide urethane (TPU) monolayer. Then, the dendron layer was introduced on the silylated surfaces by esterification reaction (FIG. 16A). After introduction of a dendron layer, probe and target DNA molecules were covalently attached to the dendron apexes. A 20-bp part at the top of probe DNA was designed for hybridization with a linker DNA and another 15-bp part consisting of successive cytosine sequence at the bottom was inserted to give a free space to a 5-nm gold nanoparticle tethered to a linker DNA (FIG. 18B). A linker DNA was designed to hybridize to the probe DNA on a substrate and to the target DNA on an AFM tip. For visualization of linker DNA molecules on transmittance electron microscopy (TEM), 5-nm gold nanoparticles were used.

Before an AFM experiment, gold labeled linker DNA molecules were initially hybridized to the probe DNA molecules on silicon substrates, and then the target DNA modified AFM tip and the linker DNA hybridized substrate were located on AFM. Each AFM tip was approached and retracted repeatedly for 5 times at one point, and scanned 5 points totally. Because the rupture force between a free 40-bp stretch of linker DNA and a target DNA is stronger than that between another 20-bp part of linker DNA and a probe DNA, it was expected that the AFM tip could remove a linker DNA from the substrate. After the scan, AFM tips were visualized by TEM without any further treatments.

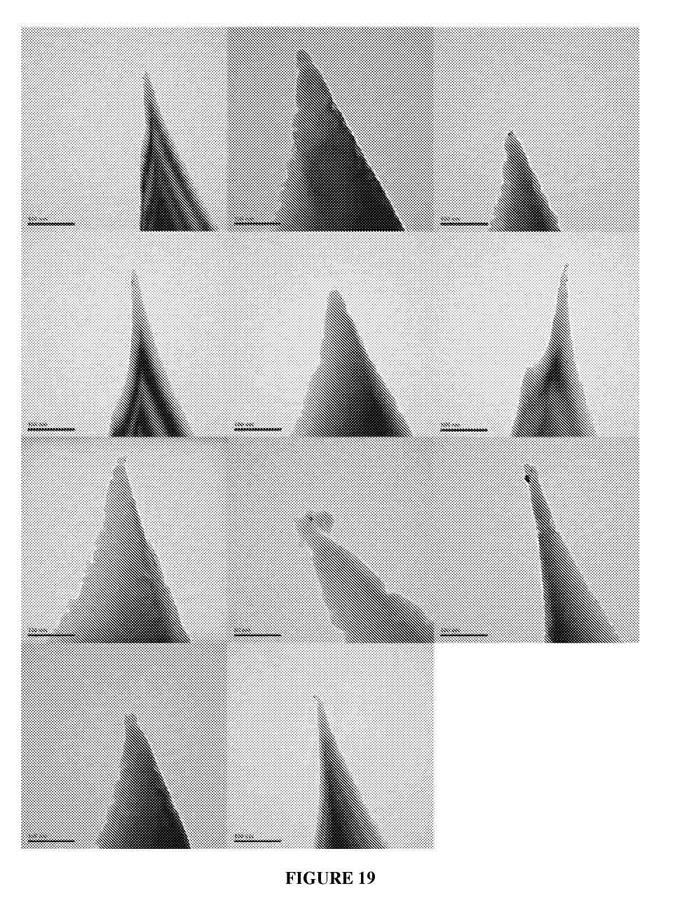

Because each linker DNA was labeled with only one gold nanoparticle, the number of gold nanoparticles on the AFM tip would correspond to the number of linker DNA molecules that interacted with the target DNA molecules on the AFM tip. As shown in FIG. 18C, only one gold nanoparticle on the top of AFM tip was observed. A total of sixteen AFM tips were tested and twelve tips showed only one gold nanoparticle and the others didn't show any gold nanoparticles (FIG. 19).

Hybridization of another gold-DNA conjugate was attempted to the captured linker DNA's free ssDNA part to clearly confirm that the gold labeled linker DNA on the tip was introduced by specific interaction (FIG. 18D). As shown in FIG. 18E, two gold nanoparticles on an AFM tip were observed. These results indicate that the dendron modified AFM tips and substrates provide a specific single molecular interaction.

Methods of the invention can be used to make the AFM tips that recognize only single molecular interactions with a significantly higher success probability (e.g., at least about 75%) than the currently available methods. TEM images of the AFM tips showed the direct evidence of single specific interactions. Some aspects of the invention use dendron coated tips which significantly increase the successful probability of fabricating AFM tips that are suitable for measuring the single molecular force between biomolecules, single molecule fabrications, and other applications for controlling only a single molecule. Compositions and apparatuses of the invention also provide a useful tool to study single catalytic reactions and single electron transfer mechanisms, for example, by exchanging the gold nanoparticles with enzymes, organometallic catalysts, or semiconducting nanoparticles.

Additional objects, advantages, and novel features of this invention will become apparent to those skilled in the art upon examination of the following examples thereof, which are not intended to be limiting. In the Examples, procedures that are constructively reduced to practice are described in the present tense, and procedures that have been carried out in the laboratory are set forth in the past tense.

### EXAMPLES

### Example 1

### A Silane Coupling Agent N-(3-(triethoxysilyl)propyl)-O-polyethyleneoxide

A silane coupling agent N-(3-(triethoxysilyl)propyl)-O-polyethyleneoxide urethane (TPU) was purchased from Gelest. All other chemicals are of reagent grade from Sigma-Aldrich. UV-grade fused silica plates were purchased from CV1 Laser. Polished Si(100) wafers (dopant: phosphorus; resistivity: 1.5-2.1 Ω·cm) were purchased from MEMC Electronic Materials. Deionized water (18 MΩ·cm) was obtained by passing distilled water through a Barnstead E-pure 3-Module system. All short oligonucleotides were purchased from Bionics (Korea).

### Cleaning the Substrates

Silicon wafers and fused silica plates (for dendron surface coverage analysis; data not shown) were sonicated in Piranha solution [concentrated H₂SO₄:30% H₂O₂=7:3 (v/v)] for 4 h. The substrates were then washed thoroughly with deionized water and subsequently immersed in a mixture of deionized water, concentrated ammonia solution, and 30% hydrogen peroxide [5:1:1 (v/v/v)] in a Teflon beaker. The beaker was placed in a water bath and heated to 80° C. for 10 min. The substrates were taken out of the solution and rinsed thoroughly with deionized water. The substrates were again placed in a Teflon beaker containing a mixture of deionized water, concentrated HCl, and 30% H₂O_{2 [}6:1:1 (v/v/v)]. The beaker was heated to 80° C. for 10 min. The substrates were taken out of the solution and washed thoroughly with deionized water. The clean substrates were dried in a vacuum chamber (30-40 mTorr) for about 30 min and used immediately for the next steps.

### AFM Probe Pretreatment

Standard rectangular-shaped silicon cantilevers with pyramidal tips (SICON, Applied NanoStructures; k=0.2 N/m) were first oxidized by dipping in an 80% nitric acid solution and then heated to 80° C. for 20 min. The cantilevers were removed from solution and washed thoroughly with deionized water. The clean cantilevers were dried in a vacuum chamber (30-40 mTorr) for about 30 min and used immediately for the next steps.

### Silylation

Silicon/silica substrates and cantilevers were immersed in anhydrous toluene (20 mL) containing a silane coupling agent (0.20 mL) under a nitrogen atmosphere for 4 h, washed with toluene, and then heated for 30 min at 110° C. The substrates were immersed in toluene, toluene-methanol [1:1 (v/v)], and methanol in a sequential manner and sonicated for 3 min in each washing solution. The cantilevers were rinsed thoroughly with toluene and methanol in a sequential manner. The resulting substrates and cantilevers were dried under vacuum (30-40 mTorr).

### Preparation of Dendron Modified Surfaces

The above hydroxylated substrates and cantilevers were immersed for 12-24 h in a methylene chloride solution comprising the 27-acid dendron (1.0 mM), a coupling agent, 1,3-dicyclohexylcarbodiimide (DCC) (29.7 mM), and 4-dimethylaminopyridine (DMAP) (2.9 mM). The 27-acid dendron, 9-anthrylmethyl-3-({[tris({[(1-{tris[(2-{[(tris{[2-carboxyethoxy]methyl}-methyl)amino]carbonyl}ethoxy)methyl]methyl}amino)carbonyl]-2-ethoxy}methyl)methyl]-amino}carbonyl)propylcarbamate (or 27-acid, FIG. 16B) used in this work was prepared according to a known procedure. These compounds were dissolved in a minimum amount of dimethylformamide (DMF) prior to adding into methylene chloride. After the reaction, the substrates were immersed in methylene chloride, methanol, and water in a sequential manner, and were sonicated for 3 min at each washing step. The cantilevers were rinsed thoroughly with methylene chloride, methanol, and water in a sequential manner. The substrates and cantilevers were washed with methanol, and dried under vacuum (30-40 mTorr).

### Deprotection of the 9-Anthrylmethoxycarbonyl Group

The dendron modified cantilevers and substrates were stirred for 2 h in a methylene chloride solution containing trifluoroacetic acid (TFA) (1.0 M). After the reaction, they were soaked in a methylene chloride solution with 20% (v/v) diisopropylethylamine (DIPEA) for 10 min. The substrates were sonicated in methylene chloride and methanol each for 3 min, and the cantilevers were rinsed thoroughly with methylene chloride and methanol in a sequential manner. The substrates and cantilevers were dried under vacuum (30-40 mTorr).

### Preparing NHS-Modified Substrates

The above amine-terminated substrates and cantilevers were immersed in an acetonitrile solution containing di(N,N′-succinimidyl)carbonate or N,N′-disuccinimidyl carbonate (DSC) (25 mM) and DIPEA (1.0 mM) for 4 h under nitrogen atmosphere (FIG. 16A). After the reaction, the substrates and cantilevers were placed in dimethylformamide for 30 min and washed with methanol. The substrates and cantilevers were dried under vacuum (30-40 mTorr).

### Immobilization of DNA

The above NHS-tethered substrates and cantilevers were soaked in a DNA solution (40 μM in 25 mM NaHCO₃ buffer (pH 8.5) with 5.0 mM MgCl₂) for 12 h. The DNA molecule has a terminal amino group that reacts with the activated NHS-ester anchored on the substrates (FIG. 16A). After the reaction, the substrates and cantilevers were stirred in a hybridization buffer solution (2×SSPE buffer (pH 7.4) containing 7.0 mM sodium dodecylsulfate) at 37° C. for 1 h, and were rinsed thoroughly with water to remove non-specifically bound oligonucleotides. The substrates and the cantilevers were dried under vacuum (30-40 mTorr).

### Control Experiments

The silicon substrates and the cantilevers were reacted with 0.1% (v/v) APDES solution in toluene for 3 h (FIG. 16C). After silylation, the substrates and the cantilevers were treated as described above except without the dendron.

### Gold Labeled DNA

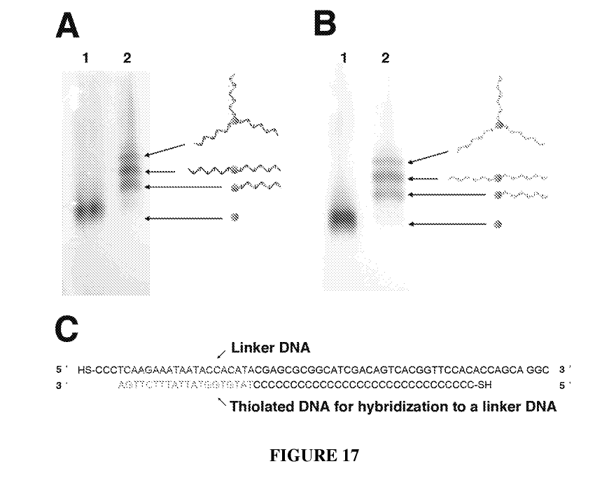

The previously reported synthesizing methods for gold labeled DNA were adopted. See, for example, Alivisatos et al., in Nature, 1996, 382, 609-611; Loweth et al., in Angew. Chem. Int. Ed., 1999, 111, 1925-1929; and Fu et al., J. Am. Chem. Soc., 2004, 126, 10832-10833. Thus, bis(para-sulfonatophenyl)phenylphosphine dehydrate dipotassium salt (1 mg) was added to a gold nanoparticle (AuNP) solution (10 mL), and the solution was incubated at 22° C. overnight. Then the AuNPs were precipitated by adding NaCl until the color of the solution turned blue. After centrifugation, the supernatant was removed thoroughly and the AuNPs were redispersed in 0.5×TBE buffer. The concentration of the AuNPs was 2 μM. Then the AuNP solution was mixed with tholated DNA solution at a molar ratio of 1:1 and incubated at 22° C. overnight. After the incubation, only a single DNA immobilized AuNP was separated by 3% agarose gel electrophoresis with 0.5×TBE buffer as a running buffer. FIG. 17. The band corresponding to the single linker DNA immobilized AuNP was sliced from the gel and placed in a dialysis membrane filled with 0.5×TBE buffer. After another running, the solution in the membrane was collected carefully, and the DNA immobilized AuNPs were concentrated by centrifugation. These concentrated AuNP labeled DNA molecules were redispersed in 0.5×TBE buffer containing 50 mM NaCl. The final concentration of the AuNP labeled DNA solution was about 100 nM. The concentration of each solution was estimated by UV-vis spectroscopy.

### Single Linker DNA Capturing

All single linker DNA capturing experiments were performed with a NanoWizard AFM (JPK Instrument). All AFM experiments were carried out in fresh 0.5×TBE buffer (pH 8.0) containing 50 mM NaCl at room temperature. Each AFM tip was approached and retracted repeatedly for 5 times at one point, and scanned 5 points totally. Tip velocity was fixed at 0.2 μm/s.

### Example 2

Mung bean nuclease, which is able to selectively lyse the single stranded DNA (ssDNA), was selected as an enzyme to be used in the experiment. S1 nuclease can replace this enzyme, however, any enzymes that can selectively lyse the ssDNA can be used. The AFM tip was attached with: 5′—NH₂-TAA AAA AAA AAA AGC GGT AAG GGA AAT CGC GTC ATA AAA AAA TAT CGA GT-3′. And a substrate surface was attached with: 5′-NH₂-ACT CGA TAT TTT TTT ATG ACG CGA TTT CCC TTA CCG CTT TTT TTT TTT TA-3′

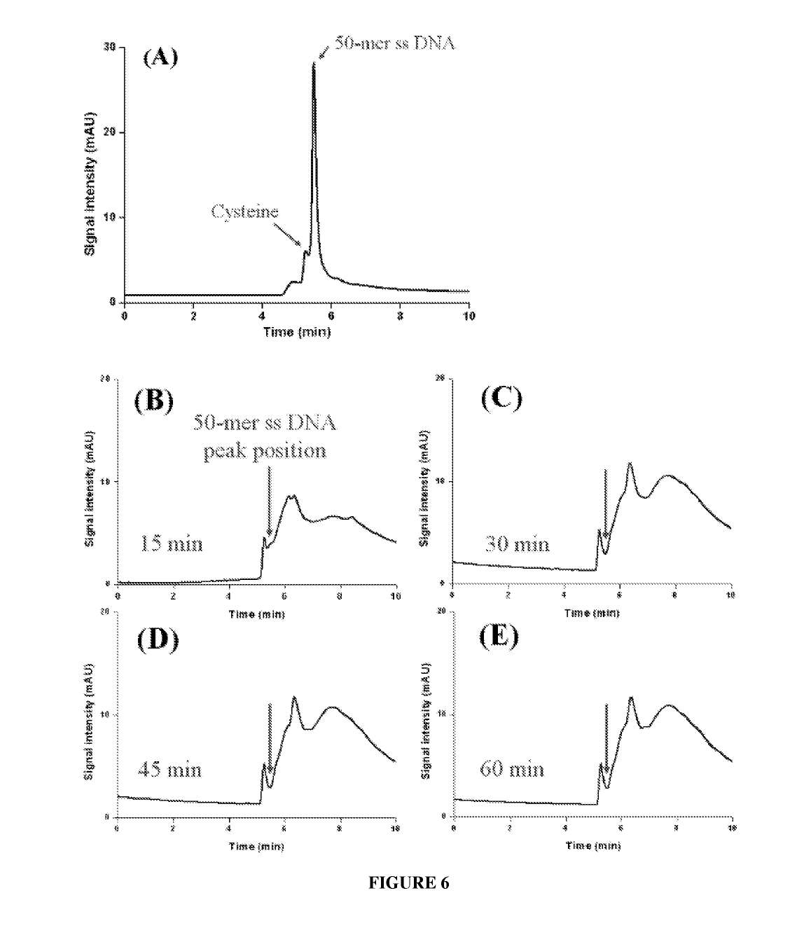

The amino group on 5′-terminal end was used to immobilize the oligonucleotide onto the surface. The length of 50 nucleotides was used to allow discrimination with the short DNAs cleaved by the enzyme. Synthesized DNAs and the reaction products with Mung bean nuclease were analyzed using high performance liquid chromatography (HPLC) to determine if DNAs were lysed by Mung bean nuclease and if there was selectivity between dsDNA and ssDNA. Synthesized ssDNA for the AFM tip was reacted with Mung bean nuclease and analyzed by HPLC using a C-18 reverse phase column. The results are shown in FIGS. 6A-6E, where FIG. 6A shows the detection (i.e., retention) time of intact ssDNA before adding Mung bean nuclease to the ssDNA solution. After determining the detection time, Mung bean nuclease was added to the DNA solution and the extent of lysis was observed 15 minutes. Shorter ssDNA from enzymatic cleavage is detected at later time than the larger intact ssDNA due to the reduction in the negative charge of the DNA backbone. As shown in FIG. 6B, most of the 50-mer ssDNA was already lysed within 15 minutes, and after 30 minutes (FIG. 6C) almost all of 50-mer ssDNA was lysed. The buffer used in the experiment and the HPLC conditions are as follows: Mung bean nuclease reaction buffer (pH 4.6); 30 mM sodium acetate, 50 mM sodium chloride, 1 mM zinc acetate, 1 mM cysteine, 0.001% Triton X-100, 5% glycerol, HPLC running buffer (pH 5.0); 30 mM sodium acetate, 100 mM NaCl, 1 mM zinc acetate, 5% glycerol; HPLC Eluent: running buffer: MeOH (V/V)=7:3; Flow rate=2 mL/min; Temperature=25° C.; DNA concentration=3 mM; Mung bean nuclease=90 unit.

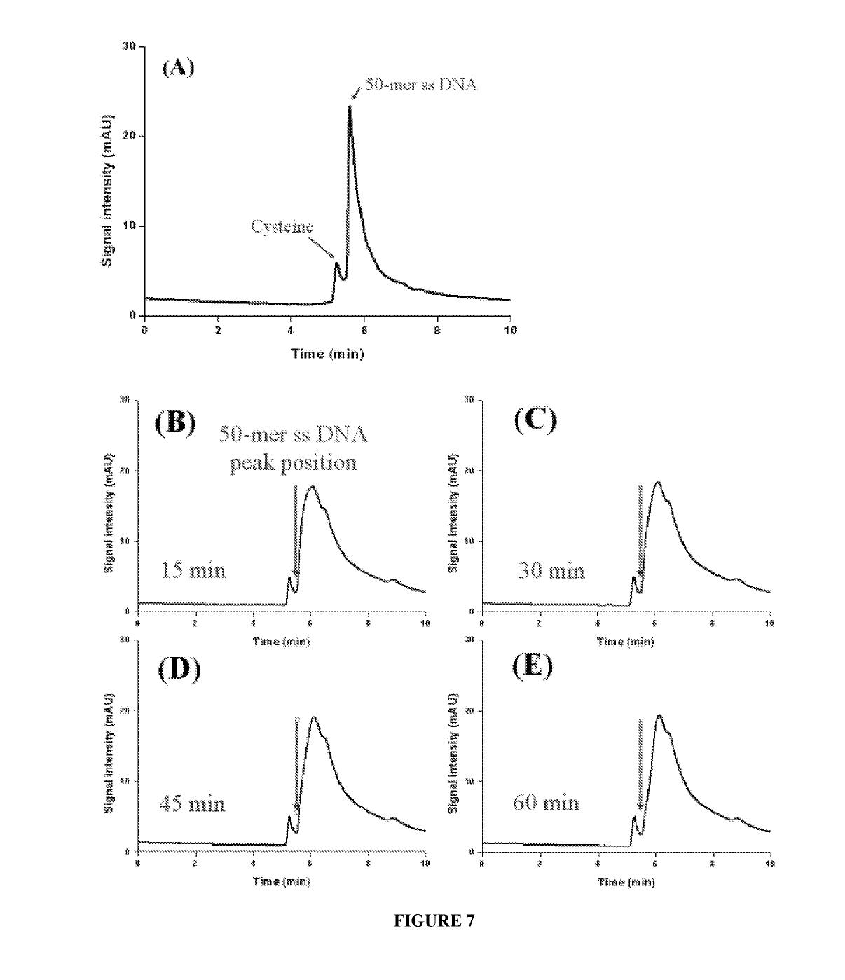

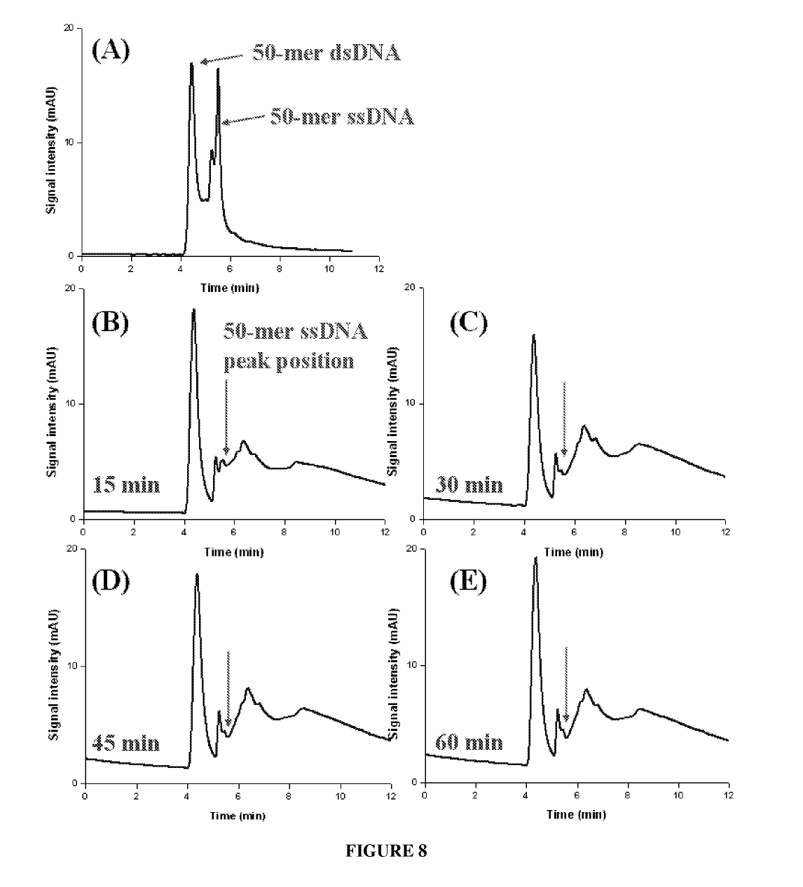

Similarly, ssDNA for the matrix surface was reacted the enzyme and analyzed by HPLC under the same conditions as described above and the results are shown in FIGS. 7A-7E. FIG. 7A shows the HPLC plot of ssDNA solution before adding Mung bean nuclease, whereas Figures B-E show HPLC plot of the same solution after 15 minutes, 30 minutes, 45 minutes and 60 minutes, respectively, after the addition of the enzyme. Results shows that both the AFM tip DNA and the matrix surface DNA were completely lysed within 60 minutes.

ssDNA vs. ddDNA

A mixture of dsDNA and ssDNA was exposed to Mung bean nuclease under the similar conditions to determine the selectivity between ssDNA and dsDNA. Double stranded DNA was formed by hybridizing a complementary ssDNA of with one of the ssDNAs above. Since the dsDNA is more negatively charged on its backbone than the ssDNA, the detection (i.e., retention) time was shorter than that of ssDNA. The retention times of ssDNA and dsDNA are shown in FIG. 8A. FIGS. 8B-8E are the HPLC analysis results in 15 minutes, 30 minutes, 45 minutes and 60 minutes, respectively, after adding the enzyme. As can be seen from FIGS. 8A-8E, dsDNA remained unlysed and only ssDNA was selectively lysed.

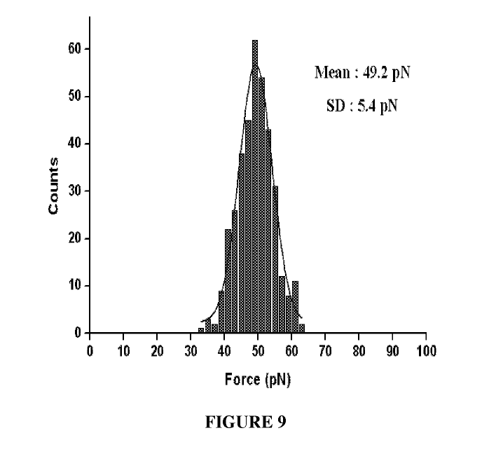

Using the mesospaced technology, an AFM tip and a matrix surface with 50-mer ssDNAs disclosed in the above experiments were modified (i.e., attached). The hybridization force of DNA-DNA was measured in a buffer solution for the Mung bean nuclease reaction. The result showed hybridization force was 49.2±5.4 pN (FIG. 9).

An experiment was conducted to determine the time required for Mung bean nuclease to lyse the DNA on the AFM. Briefly, Mung bean nuclease was added and the hybridization force was measured very slowly (e.g., 9 sec per 1 force measurement). The results showed that all eight (8) samples used in the experiment lost the hybridization force within 1 hour. Hydrolysis of ssDNA on the actual AFM was repeated using ssDNAs that were attached to a dendron modified AFM tip and a dendron modified matrix surface. The ssDNA was attached via crosslinking with the amine group of dendron. After installing the tip and the matrix in the AFM, buffer solution was added followed by Mung bean nuclease. The tip was induced to approach to the matrix surface to identify the position where the DNA-DNA interaction force was measured, and then the matrix surface was kept lightly pressed by the tip for an hour from Mung bean nuclease addition site. After which the tip was quickly lifted from the surface, immersed for 10 minutes in the 0.01% solution of dodecyl sulfate (SDS) dissolved in the reaction buffer of Mung bean nuclease, washed with sterilized water, and stored in vacuum.

### Example 3

### Modification of the AFM Tip with Single Molecule Using Antigen-Antibody Interaction

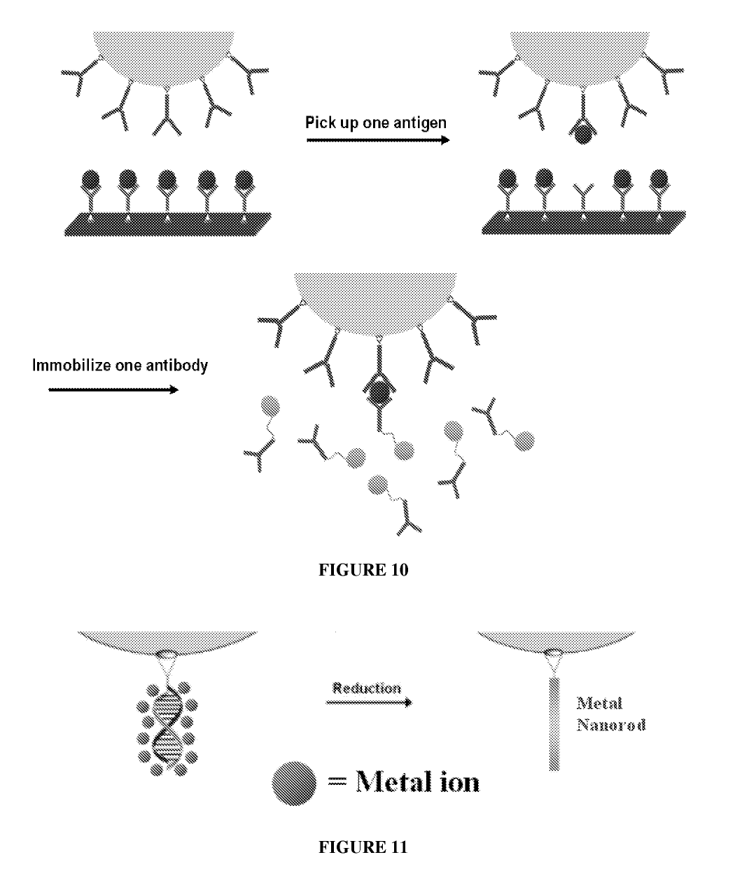

In addition to methods that use DNA-DNA interaction as illustrated in Example 1 and 2 above, the apex of the AFM tip is modified with single molecule using antigen-antibody interaction (FIG. 10). After silicon (Si) wafer surface is modified with dendron using mesospaced technology, dendron is bound to rabbit anti-BSA (bovine serum albumin) through crosslinking reaction. Upon washing off the remaining rabbit anti-BSA solution, the rabbit anti-BSA bound to the Si wafer surface and BSA in solution are induced to specifically bind each other through antigen-antibody reaction by immersing the matrix in the solution containing BSA. As with the Si wafer, the AFM tip is first modified with dendron, and modified again with rabbit anti-BSA through crosslinker. The Si wafer and the AFM tip are installed in the AFM apparatus, and then the AFM tip is induced to approach to the Si surface. Through repeated trials of approaching, the BSA immobilized on the Si wafer surface is transferred to the AFM tip through antigen-antibody reaction. The resulting AFM tip is then exposed to a solution containing rabbit anti-BSA resulting in an AFM tip having only one antigen-antibody-antigen complex on the apex.

### Example 4

### Metal Nanorods on the AFM Tip

Many metallic ions can bind to a dsDNA through an electrostatic interaction and coordinate covalent bonding. The bound metal ions can be reduced to metallic particles through a reduction process. See, for example, J. Mater. Chem., 2004, 14, 611-616. Suitable metal ions that can be reduced include, but are not limited to, copper, platinum and silver. One of the advantages of such a metallic reduction method is that thickness of nanowires can be controlled through adjusting reduction time.

A method for forming silver (among many kinds of metals) nanowire on the apex of the AFM tip is illustrated herein. See FIG. 11. Four solutions are required for silver metallization. Compositions of each solution are as follows: Solution 1: 10 mM CsNO₃ in water; Solution 2: 10% NH₄OH, 10 mM CsNO₃, 0.1 mM AgNO₃ in water; Solution 3: 10% NH₄OH, 10% formaldehyde, 10 mM CsNO₃ in water; and Solution 4: 10% NH₄OH, 10% formaldehyde, 10 mM CsNO₃, 0.1 mM AgNO₃ in water. It is believed that inter alia Solution 1 plays a role in preventing undesired metallization covering the silicon oxide surface with Cs⁺ ions. Solution 2 provides silver ions bind in between dsDNA. Solution 3 allows formation of seeds for metallization reducing Ag⁺ in the solution 2 that is bound to the dsDNA. Finally, Solution 4 provides crystal growth starting from the seeds formed by solution 3.

To form silver nanowires on the apex of the AFM tip, hybridization of DNA on the AFM tip obtained in Example 1 and 2 above is used. Hybridization is conducted by cooling the hybridization buffer solution slowly from 90° C. to room temperature. The resulting AFM tip is immersed in Solution 1 for 30 minutes to block the surface with Cs⁺ ions. The tip is then immersed in Solution 2 for about 30 minutes, washed with Solution 1 for 5 seconds to remove excess Ag⁺ ions, and immersed in Solution 3 for 5 minutes to reduce Ag⁺ ions bound to DNA duplex. Finally the AFM tip is immersed in Solution 4 to form nanowires. The resulting silver nanowires are identified with TEM. The diameter of silver nanowires can controlled by adjusting the reaction time in Solution 4.

This AFM tip modified with silver nanowires can also be applied to Electrical Force Microscopy (EFM). Briefly, a conducting polymer is coated on Si wafer and topology of this conducting polymer is compared with conducting image of the EFM mode. The 2 images coincide with each other. In this way, the AFM tip modified with silver nanowires can be used to study electrical characteristics of a surface.

### Example 5

### Intercalator-Metal Catalyst on the AFM Tip

Various organic compounds and metals bind between dsDNAs. These materials are called intercalators. They include various compounds such as cyclophosphamide, melphalan, busulfan, chlorambucil, mitomycin, cysplatin, bleomucin, irinotecan, mitoxantrone, dactinomycin, etc. Advantages of these materials are in that they have various derivatives and rich applicability.

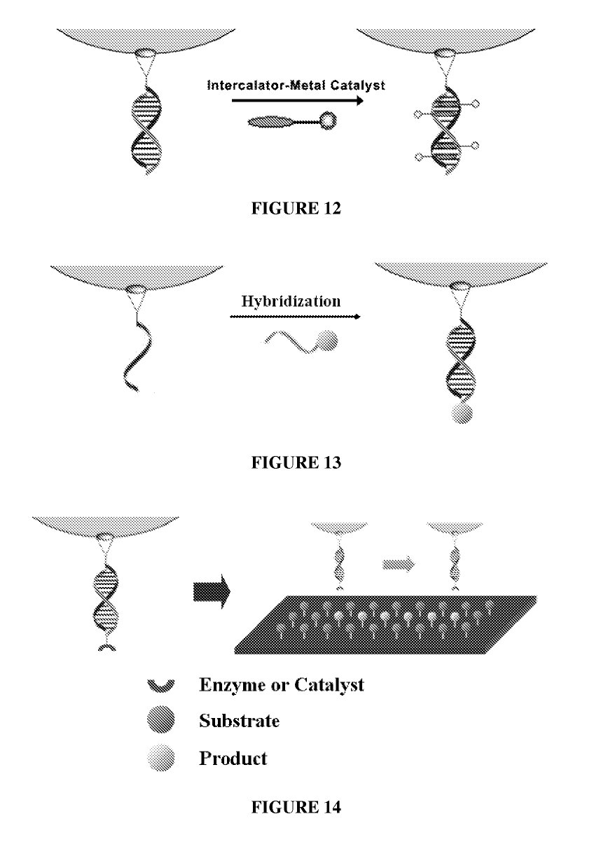

This example illustrates immobilization of a metallic catalyst on the apex of the AFM tip using a mitomycin derivative that is crosslinked on its primary amine group to a metallic catalyst. See FIG. 12.

The AFM tip is prepared using the procedure described in Example 1 and 2 above and hybridized to dsDNA using the procedure described in Example 1 and 2 above to form a dsDNA. A small amount of mitomycin is dissolved in the buffer of the same composition as that of the hybridization solution. The AFM tip is placed in the mitomycin solution at room temperature for 12 hours, removed and washed with deionized water, and dried under vacuum. After drying, mitomycin is crosslinked to a previously prepared titanium oxide nanoparticle having a primary amine group. Titanium oxide nanoparticles with a primary amine group is formed by spraying titanium tetrahydroxide in air and obtained by self-assembly reaction with APTES (amino-propyltrietoxy silane). TEM analysis shows the resulting AFM tip is modified with nanoparticles.

To verify the photocatalytic property, the resulting AFM tip is immersed in a solution containing H₂O₂ and irradiated with UV beam. Analysis of the resulting solution shows H₂O₂ is reduced indicating that the AFM modified with titanium oxide nanoparticles has a photocatalytic property.

### Example 6

### Magnetic Particle Immobilized on the AFM Tip

This example illustrates a method for immobilizing magnetic particles on the apex of the AFM tip. See FIG. 13.

To introduce an amine group onto Fe₃O₄ nanoparticles, APTES is self-assembled. and DNA is immobilized on Fe₃O₄ surface using UV crosslinking method. The resulting Fe₃O₄ is centrifuged to remove the excess DNA. Using the procedure of Example 1 above, ssDNA that is complementary to the ssDNA introduced onto the Fe₃O₄ nanoparticles is immobilized on the apex of the AFM tip. The Fe₃O₄ nanoparticles and the AFM tip are hybridized to each other using the procedure of Example 1 and 2.

The AFM tip modified with magnetic particles is applicable to magnetic force microscopy (MFM). Magnetization of Fe₃O₄ is induced by placing a strong magnet over the AFM tip, and then topology image and magnetic force image on Si wafer containing scattered magnetic materials are compared. In this way, the AFM tip can be used in a high resolution magnetic force microscopy.

### Example 7

### Site Specific Enzyme or Catalytic Reaction on Surface

As illustrated in FIG. 14, protein kinase can be attached to the apex of the AFM tip by hybridizing the ssDNA that is attached to the AFM tip (prepared following the procedure of Example 1 and 2 above) and a DNA linked to a protein kinase.

Using a mesospaced technology and a crosslinking method, an oligopeptide with a serine residue terminal is attached to a silicon wafer surface that has surface bound dendrons. The resulting AFM tip and the Si wafer are installed in the AFM. The AFM tip is allows to contact the Si wafer surface in a buffer solution containing ATP. By moving the tip slowly on the surface, the hydroxyl group on the trajectory of the tip is replaced with phosphate group. In this manner, a high resolution pattern is formed, and pattern amplification and selective introduction of other compounds can be obtained using the differences in functional groups between the trajectory of the tip and the other parts.

### Example 8

### Single Molecule Attachment

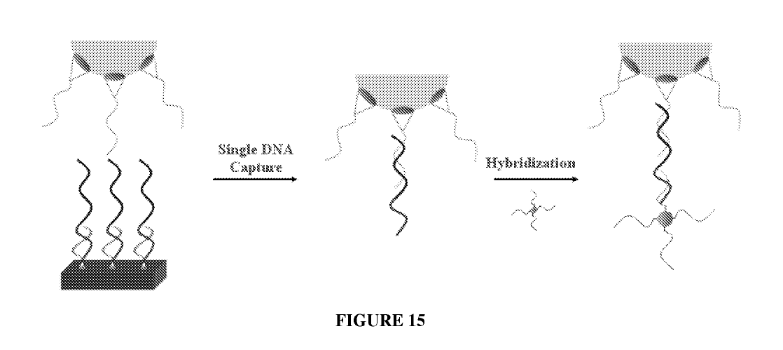

This example illustrates a method for introducing nanoparticles linked to a DNA to the apex of the AFM tip. See FIG. 15.

A relatively long DNA is attached to an AFM tip having a surface bound dendron. A relatively shorter DNA is attached to a silicon wafer. A linker DNA that can hybridize to the DNAs of both AFM tip and silicon wafer could be hybridized, is hybridized to the DNA on the silicon wafer. By placing the AFM tip near the silicon surface, the remaining portion of the linker DNA that is attached to the silicon wafer surface was hybridized to the AFM tip DNA. Upon separating the AFM tip from the silicon wafer, the linker DNA is drawn to the AFM tip by the relative binding force difference. To verify successfulness of this method, a DNA with a sequence that is capable of hybridizing to the unhybridized portion of the captured linker DNA is introduced onto the gold nanoparticles. Hybridization of the gold nanoparticle-linked DNA showed that only one nanoparticle was attached to the apex of the AFM tip.

The result shows that nanoparticles, nanowires, catalyst, metals, chemical molecules and biomolecules can be immobilized on the apex of the AFM tip.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method for modifying a solid substrate surface comprising:
attaching a receptor to a convex surface of a first solid substrate surface comprising a plurality of dendrons to produce a receptor-dendron complexed substrate comprising a plurality of receptor-dendron complexes;
contacting the receptor-dendron complexed substrate with a ligand that is bound to the surface of a second solid substrate under conditions sufficient to produce a dendron bound receptor-ligand complexed solid substrate wherein only a portion of the plurality of receptors is complexed to the ligand; and
modifying the dendron bound receptor-ligand complex to produce a surface modified solid substrate comprising a surface bound dendron that is attached to the receptor-ligand complex.

2. The method of claim 1, wherein said method produces about 3 or less receptor-ligand complex that is attached to the surface bound dendron.

3. The method of claim 2, wherein said method produces only a single receptor-ligand complex that is attached to the surface bound dendron.

4. The method of claim 1, wherein the receptor-ligand complex is a double stranded oligonucleotide, antigen-antibody complex, oligopeptide-small molecule complex, or oligopeptide-oligopeptide complex.

5. The method of claim 4, wherein the receptor-ligand complex is a double stranded oligonucleotide.

6. The method of claim 5, wherein said step of modifying the receptor-ligand complex further comprises:
contacting the double stranded oligonucleotide with a metal ion under conditions sufficient to form a double stranded oligonucleotide-metal ion complex; and
reducing the metal ion under conditions sufficient to produce the surface modified solid substrate comprising a surface bound metal nanorod.

7. The method of claim 5, wherein said step of modifying the receptor-ligand complex further comprises contacting the double stranded oligonucleotide with an intercalator-metal catalyst complex under conditions sufficient to produce the surface modified solid substrate comprising a surface bound double stranded oligonucleotide with the intercalator-metal catalyst intercalated therein.

8. The method of claim 5, wherein said step of modifying the receptor-ligand complex comprises:
denaturing the double stranded oligonucleotide to produce a single strand oligonucleotide-bound substrate; and
hybridizing the single strand oligonucleotide with
(i) a labeled complementary oligonucleotide under conditions sufficient to produce the surface modified solid substrate comprising a surface bound labeled double-stranded oligonucleotide; or
(ii) a complementary oligonucleotide comprising an enzyme or a catalyst under conditions sufficient to produce the surface modified solid substrate comprising the enzyme or the catalyst that is attached to a surface bound double-stranded oligonucleotide.

9. The method of claim 8 further comprising the step of cleaving from the solid substrate surface at least a portion of the unbound single stranded oligonucleotides prior to said step of denaturing the double stranded oligonucleotide.

10. The method of claim 5, wherein said step of contacting the receptor-dendron complexed substrate with a ligand that is bound to the surface of a second solid substrate comprises:
contacting a first solid substrate surface bound ssDNA with a linker ssDNA that is hybridized to a ssDNA that is attached to the second solid substrate surface under conditions sufficient to produce the receptor-ligand complex bound solid substrate, wherein the linker ssDNA comprises:
(i) a first DNA portion that is capable of hybridizing to the ssDNA that is attached to the surface of the first solid substrate;
(ii) a second DNA portion that is capable of hybridizing to the ssDNA that is attached to the surface of the second solid substrate surface; and
(iii) optionally a probe, a label, or a combination thereof.

11. The method of claim 10, wherein the linker ssDNA comprises a probe.

12. The method of claim 4, wherein the receptor-ligand complex is an antigen-antibody complex.

13. The method of claim 12, wherein said step of modifying the receptor-ligand complex comprises contacting the antigen-antibody complex with a second antibody under conditions sufficient to produce the surface modified solid substrate comprising a surface bound complex of antibody-antigen-second antibody.

14. The method of claim 12, wherein said step of modifying the receptor-ligand complex further comprises adding an enzyme-linked secondary antibody under conditions sufficient to produce the surface modified solid substrate comprising a surface bound complex of antibody-antigen-enzyme linked secondary antibody.

15. The method of claim 12, wherein said step of modifying the receptor-ligand complex further comprises adding a metal-linked secondary antibody under conditions sufficient to produce the surface modified substrate comprising a surface bound complex of antibody-antigen-metal linked secondary antibody.

16. The method of claim 1, wherein the the surface of the second solid comprises a plurality of surface bound dendrons and the ligand is bound to the surface of the second solid substrate by the surface bound dendron.

17. (canceled)

18. The method of claim 1, wherein the dendron is of the formula:
Z—[R¹]ₘ-Q¹-{[R²-Q²]ₐ-{(R³-Q³)_{b}-[(R⁴-Q⁴)_{c}-(R⁵—Y)ₓ]_{y}}_{z}}ₙ
wherein
each of m, a, b, and c is independently 0 or 1;
x is 1 when c is 0 or when c is 1, x is an integer from 1 to the oxidation state of Q⁴−1;
y is 1 when b is 0 or when b is 1, y is an integer from 1 to the oxidation state of Q³−1;
z is 1 when a is 0 or when a is 1, z is an integer from 1 to the oxidation state of Q²−1;
n is an integer from 1 to the oxidation state of Q¹−1;
Q¹ is a central atom having the oxidation state of at least 3;
each of Q², Q³ and Q⁴ is independently a branch atom having the oxidation state of at least 3;
each of R¹, R², R³, R⁴, and R⁵ is independently a linker;
Z is the functional group that is attached to a receptor; and
each of Y is independently a functional group on the terminus of said base portion,
wherein a plurality of Y are attached to said first surface of said solid support, provided the product of n, x, y, and z is at least 3.

19. The method of claim 18, wherein Z comprises a heteroatom selected from the group consisting of N, O, S, P, and a combination thereof.

20. The method of claim 1, wherein the first solid substrate is an atomic force microscope tip.

21. A solid substrate adapted for performing an analytical analysis comprising a convex surface, wherein said convex surface comprises a plurality of surface bound dendrons, and wherein only a portion of the surface bound dendrons comprises a receptor adapted for forming a complex with a ligand.

22. The solid substrate of claim 21, wherein said solid substrate is an atomic force microscope tip.

23. The solid substrate of claim 21, wherein said dendron is of the formula:
Z—[R¹]ₘ-Q¹-{[R²-Q²]ₐ-{(R³-Q³)_{b}-[(R⁴-Q⁴)_{c}-(R⁵—Y)ₓ]_{y}}_{z}}ₙ I
wherein
each of m, a, b, and c is independently 0 or 1;
x is 1 when c is 0 or when c is 1, x is an integer from 1 to the oxidation state of Q⁴−1;
y is 1 when b is 0 or when b is 1, y is an integer from 1 to the oxidation state of Q³−1;
z is 1 when a is 0 or when a is 1, z is an integer from 1 to the oxidation state of Q²−1;
n is an integer from 1 to the oxidation state of Q¹−1;
Q¹ is a central atom having the oxidation state of at least 3;
each of Q², Q³ and Q⁴ is independently a branch atom having the oxidation state of at least 3;
each of R¹, R², R³, R⁴, and R⁵ is independently a linker;
Z is functional group linked to said receptor; and
each of Y is independently a functional group on the terminus of said base portion,
wherein a plurality of Y are attached to said first surface of said solid support, provided the product of n, x, y, and z is at least 3.

24. The solid substrate of claim 21, wherein said receptor is an oligonucleotide, an oligopeptide, an antibody, an antigen, a receptor, an enzyme, aptamer, or other biologically or pharmaceutically active compounds.

25. The solid substrate of claim 21, wherein about 3 or less surface bound dendrons comprise a receptor adapted for forming a complex with a ligand.

26. The solid substrate of claim 21, wherein only one surface bound dendron comprise a receptor adapted for forming a complex with a ligand.
